(19) United States
(12) Patent Application Publication
(10) Pub. No.: US 2015/0302319 A1
(43) Pub. Date: Oct. 22, 2015

(54) DATA PROVISIONING SYSTEM AND METHOD

(71) Applicants: Michael S. Elder, Erie, PA (US); Timothy C. Weindorf, Erie, PA (US); Ahmed M. Muaydh, Van Buren Township, MI (US); Mitchell Scott Wills, Melbourne, FL (US); Brandi Elizabeth Wood, Melborne, FL (US)

(72) Inventors: Michael S. Elder, Erie, PA (US); Timothy C. Weindorf, Erie, PA (US); Ahmed M. Muaydh, Van Buren Township, MI (US); Mitchell Scott Wills, Melbourne, FL (US); Brandi Elizabeth Wood, Melborne, FL (US)

(73) Assignee: GENERAL ELECTRIC COMPANY, Schenectady, NY (US)

(21) Appl. No.: 14/344,916

(22) PCT Filed: Sep. 14, 2012
(86) PCT No.: PCT/US12/55450

§ 371 Date: Jul. 1, 2015

Related U.S. Application Data
(60) Provisional application No. 61/535,813, filed on Sep. 16, 2011.

(51) Int. Cl. G06Q 10/00; G05B 15/00; G06Q 50/06

(52) U.S. Cl. CPC G06Q 10/00; G06Q 50/06; G05B 15/00

(57) ABSTRACT

Systems and methods providing an application having one or more management modules, wherein at least one management module is configured to display a metric value, and wherein the metric value is obtained by the application based on a query of a database containing information about a fleet of assets. Embodiments of the present invention provide information to an end user in response to the end user's request regarding one or more assets from the fleet of assets. The requests may include aspects of fleet performance, and individual assets within the fleet, and may relate to energy consumption, asset health or repair status, or movement through a network.

### TECHNICAL FIELD

Embodiments of the invention relate to a system for providing information to an end user, and associated methods.

### DISCUSSION OF ART

In response to increasing amounts of data being collected, analyzed and stored, existing methods of evaluating data and presenting it in a meaningful way may be increasingly inadequate.

It may sometimes be desirable to have systems and methods for collecting, analyzing and presenting data in a meaningful way that differ from those that are currently available.

### BRIEF DESCRIPTION

In one embodiment, a system is provided that includes a data center having at least one database containing metric value information about a fleet of assets; a data communication infrastructure; and a controller operable to implement a management module that is configured to display on a display of the controller at least one metric value for the fleet of assets. In accordance with an embodiment, the controller is in the form of a user device. The at least one metric value is obtained from the data center via the data communication infrastructure. The at least one metric value includes at least one of an energy consumption metric value of the fleet of assets or a value for an energy saving system of the fleet of assets. The at least one metric value may further include a percent of time the energy saving system is in use versus the available amount of time the fleet of assets is in use and a set of determined conditions are met signifying that the energy saving system is available for use. The amount of time that the energy saving system is available for use may be based on one or more of weather, equipment condition, environmental considerations, and available usage knowledge. The energy saving system may be a trip plan fuel optimization system. The fleet of assets may include at least one rail vehicle consist having one or more powered rail vehicles, and wherein the energy saving system is a consist management system for the rail vehicle consist. The metric value may further include an amount of fuel saved by the energy saving system over a period of time. The energy saving system may be an engine control system configured to start and/or stop at least one engine of the fleet of assets. The metric value may further include a cumulative miles of travel of the fleet of assets, or a subset of the fleet of assets, within a selected period. The energy consumption metric value may include a cumulative amount of fuel used by the fleet of assets, or by a subset of the fleet of assets, over a period of time. The management module may further be configured to display one or more status values associated with assets from the fleet of assets. The management module may further be configured to display asset usage information associated with assets from the fleet of assets. The asset usage information may include one or more of information on asset movement through a network, wherein the information on asset movement through the network includes one or more of velocity, volume, expired crews, asset characteristics, or number of instances where a routing change was recommended by a network optimization system; information on asset movement in an area for asset operations, wherein the area for asset operations is a rail yard and the assets are rail vehicles; information regarding one or more of weather, traffic, environmental conditions, and route status; or data about an operator or user of an asset. The asset usage information may be displayed graphically using at least a map of a determined network through which the assets move during operation. The management module may further be configured to display on the map that includes one or more indicia of an accident, derailment, slow order, instance that caused a litigation event, a regulatory compliance regime differential based on geographic boundary, or an environmental condition. The management module may further be configured to display weather information on the map, where the weather information being displayed on the map corresponds to the weather occurring at the geographic location corresponding to a map location at a select time. The management module may be configured to respond to user input to tag an asset or a group of assets of the fleet of assets, and thereby to find, identify, or both find and identify the tagged asset or group of assets. The controller may further be configured to initiate an upload of data from an asset of the fleet of assets, or receive an upload from the asset, wherein the asset is configured to initiate the upload of data in response to a defined event detected at the asset, and wherein the defined event includes one or more of an accident, a critical fault, a mission failure, a lack of motion of the asset for a defined time, or an asset operator signal. The management module may further be configured to provide information or feedback to a supply chain logistics application, wherein the provided information or feedback includes prognostics information. The management module may be configured to perform one or more of providing an alert for operational deviations of an asset of the fleet of assets, or automatically dispatching a repair or rescue crew if movement of the asset stops unexpectedly. The management module may include a cost calculator for velocity differences, and may further be configured to display cost information based on a velocity difference between a measured velocity and a reference velocity, wherein the reference velocity includes one or more of a historical average velocity, a target velocity, or a benchmark velocity. The management module may further be configured to suggest a change to asset utilization or deployment based on one or more of an asset diagnostic condition, an asset prognostic condition, or a mission criticality factor.

In one embodiment, a data provisioning method is provided that includes querying a database for one or more asset metric values associated with corresponding one or more key performance indicators (KPI) relating to assets that are part of a fleet of assets that exist in a network; displaying the one or more metric values associated with the KPI on a map, and with one or more asset graphics associated with the assets disposed graphically on the map, wherein the respective dispositions of the asset graphics indicate location values of the assets, and wherein the asset graphics are configurable to convey information; and an application responding to the metric values associated with the assets to configure the asset graphics to reflect the associated metric values. Displaying may include retrieving an displaying the one or more metric values reflecting KPI associated with energy consumption by one or more of the assets, usage of one or more of the assets, or status of one or more of the assets.

In one embodiment, a system is provided that includes means for uploading data from a plurality of assets to a data aggregator module. The system also includes means for selecting a portion of the data from the data aggregator module based on an information request by a user. The portion selection is based on one or more of energy usage by one or more of the assets, a health status or operational condition of one or more of the assets, or a utilization status of one or more of the assets. The system further includes means for transforming the portion of the data into requested information for display to the user, and means for displaying the requested information.

In one embodiment, a data provisioning system is provided that includes an application, residing in computer memory on a processor-based controller, having one or more management modules. The application is configured to execute on at least one processor of the processor-based controller. At least one management module is configured to display a metric value, where the metric value is obtained by the application based on a query of a database containing information about a fleet of assets. At least one of the management modules may display one or more metric values, associated with energy consumption by one or more of the assets, on a display of the controller. At least one energy consumption metric value may include a usage of an energy saving system by an asset having such an energy saving system. The metric value may be associated with a determined key performance indicator (KPI). At least one of the management modules may display status values associated with asset status. At least one of the management modules may display metric values associated with asset usage information. The application may be configured to display one or more maps having weather information, or allowing a user to tag an asset or a group of assets and thereby to find and/or identify the tagged asset or group of assets. The system may be configured to enable initiation of an upload of data from one or more assets. The application may provide information or feedback (e.g., prognostics information) to a supply chain logistics application. The application may provide an alert corresponding to operational deviations of one or more assets, or automatically dispatch a repair or rescue crew if movement of the asset stops unexpectedly. The application may include a cost calculator for velocity differences, and may be configured to display cost information based on the velocity difference between a measured velocity for an asset and a reference velocity for an asset. The application may suggest a change to asset utilization or deployment based on one or more of an asset diagnostic condition, an asset prognostic condition, or a mission criticality factor.

In one embodiment, a data provisioning method is provided that includes querying a database for one or more asset metric values associated with corresponding one or more key performance indicators (KPI) relating to assets that are part of a fleet of assets that exist in a network. The method also includes displaying the one or more metric values associated with the KPI. Displaying may include showing a map and one or more assets disposed graphically on the map. The disposition of the asset graphic may indicate a location value of the actual asset. The asset graphic may be configurable to convey information. The application may respond to the metric values associated with the asset to configure the asset graphic to reflect the associated metric values. Displaying may include retrieving and displaying one or more metric values reflecting key performance indicators associated with energy consumption by one or more of the assets, usage of one or more of the assets, and status of one or more of the assets. The method may further include initiating upload of data to the database from the asset, wherein the initiating occurs at the asset, or wherein the initiating occurs remote from the asset by a user of an application.

In one embodiment, a method is provided that includes uploading data from a plurality of assets to a data aggregator module. The method also includes selecting a portion of the data from the data aggregator module based on an information request by a user. The portion selected is based on one or more of energy usage by one or more of the assets, a health status or operational condition of one or more of the assets, or a utilization status of one or more of the assets. The method may further include transforming the portion of the data into requested information for display to the user, and displaying the requested information.

### BRIEF DESCRIPTION OF THE DRAWINGS

FIG. 1 is a schematic diagram of a system according to an embodiment of the invention;

FIG. 2 is a flow diagram of a method according to an embodiment of the invention;

FIG. 3 is a flow diagram of a method according to an embodiment of the invention;

FIG. 4 shows an exemplary embodiment of a display screen of a home page of a data provisioning application of the system of FIG. 1;

FIGS. 5A, 5B, 5C, 5D, 5E, 5F, and 5G show exemplary embodiments of display screens of an energy management portion of the data provisioning application of the system of FIG. 1;

FIGS. 6A, 6B, 6C, 6D, 6E, 6F, 6G, 6H, 6I, 6J, 6K, 6L, and 6M show exemplary embodiments of display screens of an asset optimization portion of the data provisioning application of the system of FIG. 1; and

FIGS. 7A, 7B, 7C, 7D, and 7E show exemplary embodiments of display screens of a network optimization portion of the data provisioning application of the system of FIG. 1.

### DETAILED DESCRIPTION

Embodiments of the invention relate to a system for providing information to an end user in response to the end user's request regarding one or more assets from a fleet of assets, and associated methods. The requests may include aspects of fleet performance, and individual assets within the fleet, and may relate to energy management (e.g., energy consumption), asset optimization (e.g., asset health or repair status), and/or network optimization (e.g., movement of assets through a network).

As used herein, the term application or application software means a program or group of programs designed for use by one or more end users. Application software includes one or more of data retrieval programs, data request programs, data storage, data analysis programs, and/or an interactive display or other graphical user interface (GUI) for the foregoing. Application software differs from system software, which includes one or more lower-level programs that interact with application software. Examples of system software include operating systems, compilers, and related utilities.

A module, as used herein, is all or a portion of an application that handles a defined functional aspect. A series of modules may work together to form an application. A management module may be, for example, associated with a set of key performance indicators (KPI).

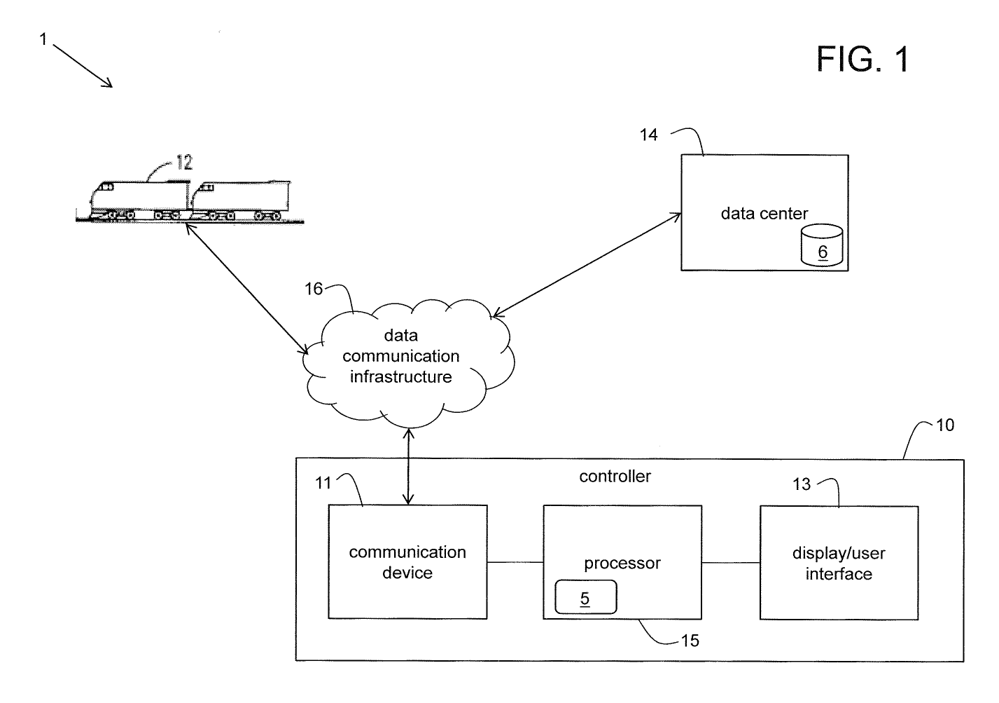

In one embodiment, a system 1 is provided that includes hardware. With reference to FIG. 1, the hardware can include a controller 10 (e.g., a processor 15; a display device, an input device, and/or other user interface 13; and a communication device 11). In accordance with an embodiment, the controller may be in the form of a user device which may be a stationary terminal, a smart phone, a tablet computer, or a like mobile device. In a larger sense, the system can further include the fleet of assets 12, and a remotely located data center 14, and the fleet of assets can be communicatively coupleable to the data center, or in some instances directly with the controller. The communication may happen though data communication infrastructure 16, such as equipment for communicating over the internet, the cloud, or a wide area network, or the like. In accordance with an embodiment, the communication device 11 may be, for example, a modem or transceiver capable of communicating with the data communication infrastructure 16 via, for example, WiFi or 3G communication protocols.

The processor can run (execute) an application 5 (e.g., a data provisioning application), and the application can cause information and data to be retrieved and shown on the display device. The application can include one or more management modules. At least one management module of the application can cause the display of a metric value. The metric value may be based on a query of a database 6 at a data center 14 containing information about a fleet of assets.

The management module can cause the display of one or more metric values associated with energy consumption, asset condition, and network usage by one or more of the assets. That is, in response to a signal, such as a user request or an event associated with the asset, the management module causes the metric value, labeled with an associated KPI, to display.

With regard to the energy consumption metric value, the metric value may relate to a usage of an energy saving system by an asset having such an energy saving system installed thereon, and/or it may relate to usage of the energy saving system by plural assets each having such an energy saving system installed thereon. In one example, a vehicle having a route plan fuel optimization system may track whether the fuel optimization system is active, or not active. Similarly, the fuel optimization system may track whether advice from the fuel optimization system is followed, or not followed, by the asset user. There may also be tracking of the degree of deviation by an asset user from an operational mode suggested by the fuel optimization system. Further, the usage of the energy saving system may be expressed as a percent of time the energy saving system is in use versus the total amount of time the asset is in use. The usage of the energy saving system may be a percent of time the energy saving system is in use verses the available amount of time the asset is in use and a set of determined conditions are met signifying that the energy saving system is available for use. The energy consumption metric value may relate to any of these in regards to an individual asset, but in embodiments, the energy consumption metric value relates to one or more of these in regards to plural assets of the fleet of assets. For example, the metric value may indicate: whether advice from fuel optimization systems of the assets is followed, or not followed, by users of the assets, as an aggregate total or average; an average degree of deviation, median degree of deviation, etc. by asset users from operational modes suggested by the fuel optimization systems; a percent of time the energy saving systems are in use versus the total amount of time the assets are in use; and/or a percent of time the energy saving systems are in use verses the available amount of time the assets are in use and a set of determined conditions are met signifying that the energy saving systems are available for use.

With regard to the energy saving system, suitable examples include an engine control system configured to start and/or stop the engine, such as General Electric Company AESS™ product; a trip plan fuel optimization system, such as General Electric Company Trip Optimizer™ System; and, a consist management system for a rail train having a plurality of the one or more assets, such as General Electric Company Consist Manager™ system. Rather than energy consumption, power usage may be included, such as General Electric Company Locotrol™ Distributed Power system.

The metric value may be associated with a determined key performance indicator (KPI). Suitable KPI include:
one or more of cumulative miles of travel of the fleet of assets within a selected period.
one or more of cumulative miles of travel of a subset of the fleet of assets within a selected period.
one or more of cumulative miles of travel of one of the assets within a selected period.
a trending value of cumulative miles of travel for selected sub-periods over a larger total period.
usage of an energy saving system within a selected period expressed as a percentage of total use time of an asset having the energy saving system equipped thereon.
an amount of fuel saved by an energy saving system over a period of time.
a cumulative amount of fuel used by an asset, or by subset of assets, over a period of time.
a cumulative amount of fuel used by all asset in the fleet over a period of time.
a cumulative amount of fuel saved by all energy saving systems equipped on the assets over a period of time.
an amount of electrical energy saved by an energy saving system over a period of time.
a cumulative number of cycles of use or trips taken by the assets during a period.
a cumulative number of cycles of use or trips taken by a selected subset of the assets, or of a single asset, during a period.
an amount of emissions from a fuel converter during a period.
an amount of emissions avoided from a fuel converter during a period through the use of an emissions reduction system coupled to the fuel converter.

The KPI can be expressed as an amount of money equivalent to an amount of energy or fuel saved by the energy saving system over a period. The application can receive information that expresses a monetary value of fuel at a determined time, and the amount of money can be determined based on the fuel monetary value at the time of fuel consumption. The monetary value may also be calculated based on the monetary value at the time of fuel purchase if such information is provided to the system.

The amount of time the energy saving system is available for use can be based on one or more of weather, equipment condition, environmental considerations, and available usage knowledge. Examples of available usage knowledge include time of day, day of week, week of year, holiday schedules, scheduled events, seasonal conditions, and network congestion information.

In one embodiment, the asset is a rail vehicle, the energy saving system is a trip plan optimization system, and the KPI is an amount of fuel saved by the asset over the course of that trip by the use of the trip plan optimization system. Additionally or alternatively, where the asset is a rail vehicle, the energy saving system can be an engine-use controller, and the KPI is an amount of fuel saved by the asset over a period by the use of the engine-use controller.

Rather than a simple representation of the metric value, the KPI can be an aggregate or a trend line of other, different KPI metric values over a period or over a group of assets. Grouping can be based on user supplied criteria, such as asset type, geographical location, asset characteristics, and the like. The KPI can be expressed as a comparison of a metric value for a selected period relative to an average metric value over a relatively longer period; for example, an amount of fuel saved on a particular day relative to an amount of fuel saved daily on average for the last month or the last year, or an amount of fuel saved on a particular day relative to an amount of fuel saved on the same day a year prior.

Rather than a trend line, the application may display a graphic associated with the fleet of assets. The application may display only metric values pre-associated with identification information of a user of the system, wherein the displayed metric values are at least a portion of a larger pool of metric value data available to the application. That is, while one company's user may access information for their company, the system may contain information for other companies.

In one aspect, the application may be responsive to express one or more of the metric values over time in graphical form. Suitable graphical forms can include graphs, tables, and the like so as to enable visualization and comparison of data sets. In particular, the graphical form can convey information relating to two or more KPIs. Suitable KPIs for comparison may include amounts of fuel saved by use of energy saving devices of the assets, number of miles of asset travel, number of trips or cycles of asset travel, total amount of energy or fuel consumed by the assets, and amount of money spent on fuel. Thus, a graph may include a fleet average of fuel saved by the fleet of assets expressed as a first line (x=time, y=fuel amount saved), a second line showing a particular asset's amount of fuel saved over the same period, and a third line showing a subset of assets of the fleet and the subset's amount of fuel saved over the period. The subset can be, for example, a fleet portion defined as an operating division, or by the assets in a defined geographical region, or an asset class. Other comparisons can include fleet subsets relative to each other, such as one geographic region relative to another, one type of asset class (e.g., one vehicle model vs. another) relative to another asset class, relative ages of assets within a class (e.g., less than 5 yrs old vs. greater than 5 yrs old).

The application may be responsive to express the metric values as a geographical reference marking a location of one or more assets of the fleet at a select time. Further, the reference marking may be displayed or coded using symbols, color, or a differentiating characteristic to express information regarding one or more assets so displayed by the application. In one instance, each reference marking may indicate a distinct asset, and information associated with the distinct asset. For example, a map may have asset markers indicating the location of the asset at a selected time (such as in near real time or at a select historical date); the marker, on mouse-over or equivalent, may further indicate information such as the asset identifier, mission details, loadout/bill of lading, equipment status, prognostics health condition, and the like.

In one embodiment, the management module may display status values associated with asset status. Suitable status values may include one or more of asset condition, asset health, asset location, and asset repair status. The asset condition may include functional state of the asset, or a set of assets, in the fleet. The asset condition may include information on the condition of all or nearly all the assets in the fleet relative to a determined desired asset condition level.

The application, and the management module, may respond to a signal to sort the assets by the asset condition value of the assets. The asset condition may include one or more faults or fault codes. Faults or fault codes indicate sensed operational parameters of one of the assets. Examples of fault codes can include the general (fault indicating only the major subsystem) and the specific (particular sensor readings). A major subsystem fault can include, e.g., engine deration. A specific fault can include, e.g., a low oil pressure sensor reading. A fault is a human readable, descriptive indication of the condition sensed on the asset being outside of a determined sensing range. A fault code, by way of contrast, is a numerical or other indicator that is not itself descriptive, but is translatable into a description of the associated condition.

The asset condition may include information indicating a mission readiness or mission capability of the asset. The asset health may include a prognostic value predictive of a functional state future or subsequent to a date of inquiry of the asset health. The application may be capable of sorting and displaying the assets by the asset(s) health level. For example, a user of the application may use the application to identify those assets that have a relatively high degree of asset health for assignment to high value or mission critical use. Conversely, the user may choose to identify those assets with relatively low health for upgrade, service, maintenance or overhaul.

The asset location may be indicated by a map marker displayed on a map. The asset location may include a determined location name or coordinates. The marker, or aspects thereof, may be selected based on asset-related information. The asset type may be reflected in the marker symbol (e.g., a locomotive may be represented by a locomotive graphic, a mining truck by a mining truck graphic, shovel equipment by a shovel equipment graphic, etc.), but further, the color may indicate asset health or operation status (in mission vs. idle), and the like. Further, the asset location may include a location between two determined locations, and further includes a distance measurement along a known route between the two determined locations.

The asset repair status may include one or more of a list of faults or fault codes, a status of completion of repair for each of the one or more listed faults or fault codes, a list of replacement parts corresponding to a repair associated with each of the one or more faults or fault codes, an availability of the replacement parts from the list of replacement parts, and a lead time or time to availability for replacement parts for those replacement parts that are not then available. The asset status repair status may include an estimated time to completion of all the repairs or a time to return to service of the asset. The asset repair status may include recommendations (Rx) for repair activities for each of the faults or fault codes.

The asset repair status may include a time/date stamp for when the faults or fault codes became available to the system, times when a corresponding Rx was provided, and the time difference between the time the fault was available and the time the Rx was provided. The asset repair status may indicate a time/date that the Rx was provided, the time/date that the Rx was closed, and the time difference between the time the Rx was provided and the time the Rx was closed. The information about the suggested repair (Rx) may be captured at the repair site or captured by the asset, and transmitted directly (or indirectly through a data center) to the application. The asset repair status or information may include a value for the average time difference for all, or a select group, of the time that faults were available to the time that the corresponding Rx was provided. In an instance, the asset repair may include a value for the average time difference for all, or a select group, of the time that Rx's were provided to the time that the corresponding Rx was closed. The application may provide asset repair information that is searchable by asset health or asset condition or fault and/or is searchable for individual assets or groups of assets. During use, the asset can be selected to indicate a history of one or more of the faults, the Rxs, and the time differences between the provision of the two. Further, the fault or fault code may be classifiable by urgency level, criticality, and/or safety level. The asset repair information may include (and display) upper and/or lower tolerance or threshold limits for each fault or fault code, as well as a fault or fault code value of the asset for comparison with the provided tolerance or limit. The tolerances may be provided from a look up table (or equivalent) or through an object oriented relational database.

The asset repair information may be sortable by a determined set of repair facilities. The asset repair information may be correlatable through the application by fault, an expertise or capability of repair facility, and location of the asset.

The application may display asset status which may include information on one or more of number of assets in the fleet, type of assets in the fleet, number of assets without a fault or fault code that is open, the total number of faults, a sortable list of the faults by type, a number of faults sortable by severity, a total number of Rx provided, and a number of false positives where a fault was indicated but no problem was found.

In one embodiment, the one management module may display metric values associated with asset usage. The asset usage may include information on asset movement through a network. The network is a system of locations interconnected by a series of transport routes. The system of locations can include loading/unloading hubs, mines/ports, passenger boarding/unboarding sites, and the like. The transport routes can include, for example, roads, marine routes, railroad tracks, flight paths, walking paths, and the like. The network can be a portion of a larger network of connected networks, and can include transport paths of differing types. For example, in some countries railroads may own or operate a number of rail yards interconnected by rail track, while each of these may be a network in its own right, each of these networks can be a portion of the larger network where these individual networks are connected. In another example, the network may be defined as a mine site where shovel equipment scoops ore and provides the ore to a mine haul truck, which transits a make-shift road from the mine site to a rail loader site and provides the ore to a rail cargo wagon, and the wagon transits a stretch of rail track to a port. At the port, the wagon is unloaded and the ore transfers to a marine vessel. The marine vessel transits a sea-lane to another port and unloads the ore to a smelter site. The smelter site transforms the ore into metal, and loads the metal on an intermodal rail wagon. The intermodal rail wagon transits the metal over rail track to an intermodal on-road vehicle. The intermodal on-road vehicle transits the metal over a road to a finisher site. The finisher transforms the metal to a finished good, and loads the finished good on a box truck. The box truck transits the finished good over a road to a retail outlet. The assets, then, may change over the course of the activity, as well as the characteristics of the locations and of the routes.

Asset usage may include information on asset movement in an area for asset operations. The area for asset operations may be a rail yard and the assets are rail vehicles. Information on asset movement through a network may include one or more of velocity, volume, expired crews, asset characteristics, and number of instances where a routing change was recommended by a network optimization system. The term “expired crews” may refer to a crew who has worked a determined, possibly regulated, period of time and needs to retire and be replaced with a fresh crew. The application may track crew operation time, and may indicate threshold levels (so that a soon expiring crew is highlightable).

The asset characteristics may include, for example, a length of a train where at least one asset is a rail vehicle disposed in the train. The asset usage information further may include information regarding one or more of weather, traffic, environmental conditions, and route status.

With regard to route status, it may include one or more of route condition, wayside equipment status, and route historical usage information. If asset usage information is displayed graphically, the display may show a map of a determined network through which the assets move during operation. The network displayed may overlay a geographic map, and more than one network may be displayed with a selected one of the networks being visually differentiated to indicate selection (e.g., bolder lines, differing color or shade, three-dimensional visual effects, and the like).

In one embodiment, the map display includes accidents, derailments, slow orders, instances that lead to litigation, regulatory compliance regime differences based on geography, and environmental conditions. Further, the map display may include weather conditions (at a selected time, including weather forecast information).

The asset usage information may include data about an operator or user of an asset. The operator or user asset usage information may be displayed over time. For example, an operator may be selected (regardless of which asset was under operation), or an asset may be selected (regardless of operator), or a route may be selected (regardless of operator or asset). The time may be dynamically selectable. The asset usage information may be displayed relative to a larger group or pool of asset users or operators so as to compare an individual to a group (that is, an operator's performance relative to an average performance of all operators, and the like).

As noted above, the network may include assets that differ from each other. Cargo or freight may be tracked through the network based at least in part on its association with an asset, where the asset is itself trackable. Further, information may be displayed that indicates a percent of train capacity that is utilized relative to full capacity. For example, on a passenger system (e.g., bus, train) if there are 100 seats and 40 riders, the capacity utilization is 40% on a particular trip through the network. Ridership over time could be plotted and displayed. For a cargo example, if the power available by the locomotives assigned to the trip is capable of pulling 100 full wagons, but only 55 wagons are full or there are only 55 wagons being hauled, the utilization is 55% on a particular trip through the network. Thus, the capacity number may be calculated based on application specific conditions.

The application may include functionality for tagging items for quick find. Tagable items may include specific assets, operators, and the like.

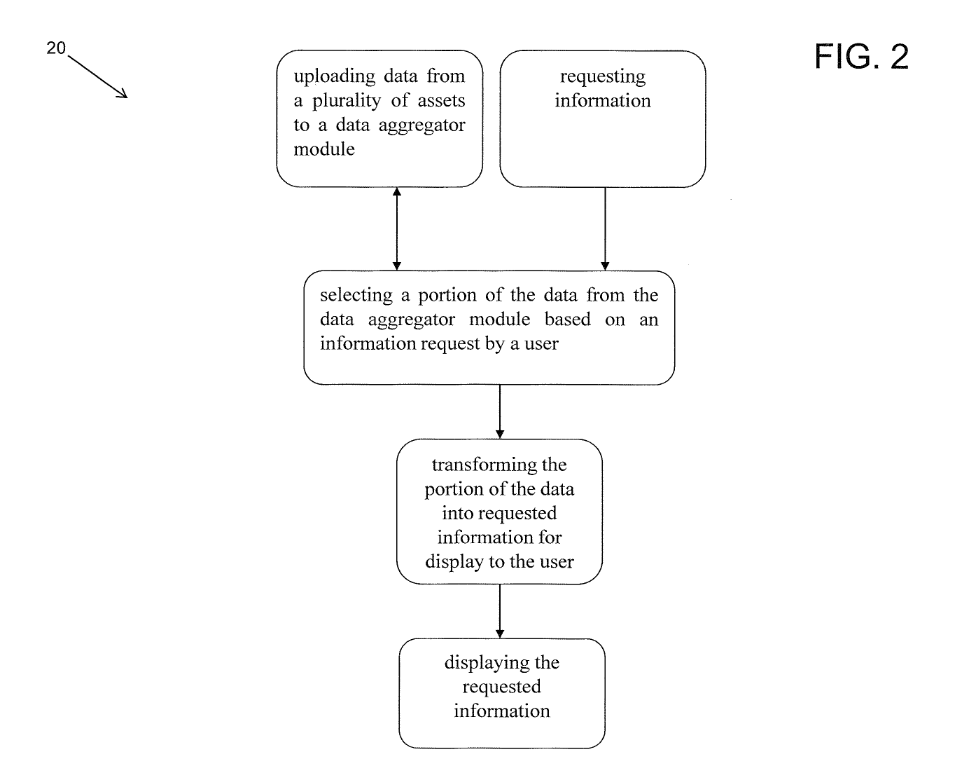

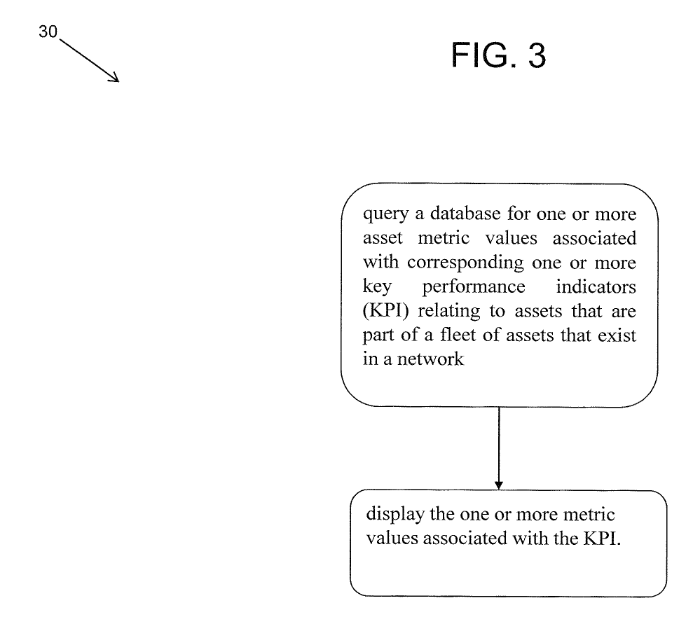

During operation, and with reference to the methods 20 and 30 of FIGS. 2 and 3 respectively, the inventive system may initiate an upload of data from one or more assets to, for example, a data aggregator module. The data aggregator module may be located on the asset(s) 12, in the data center 14, or in the controller 10, in accordance with various embodiments. This may be through a “pull” approach that signals the assets to trigger a complete or partial update of asset information. Alternatively or additionally, the asset may initiate an upload of data to system in response to a defined event that occurs with the asset. Suitable examples of a defined event may include one or more of an accident, a critical fault, a mission failure, a lack of motion for a defined time, arrival of an asset at a determined location (e.g., a repair shop or a hot information access point), or an asset operator signal. For example, a critical engine fault could trigger an upload (e.g., wireless via satellite or wireless telecommunication system) to the system, and the system may take further actions in response to the upload. Alternatively or additionally, an asset user or an asset repair serviceman may initiate an upload (or may request a status test that may automatically initiate an upload). The information from the assets load data to a database, which may be stored at a data center. Alternatively or additionally, the database may be on a computing device and distributed across multiple devices.

The database update may include variable updates based on determined conditions (e.g., weather). Subsequently, the application on the system may provide feedback to a supporting supply chain. The feedback may include information relating to prognostic analysis of the uploaded information. For example, the uploaded information may, upon analysis, indicate that a critical fault is likely to occur for an asset component and the system may respond by sending one or more notifications. The supply chain may be notified to order a replacement for the asset component, and schedule the part for delivery at a time indicated by the prognostics analysis as prior to the component failure or malfunction. The repair or maintenance services may be notified to schedule a shopping order for the asset to coincide with the ordered part arrival (prior to the malfunction).

The application also may provide one or more alerts for operational deviations. For example, the application may suggest or initiate a repair crew dispatch if an asset location does not change over a defined period of time when the expectation is that the asset should be traversing the network.

The application may include a cost calculator for velocity differentials, and may display a value associated with the current velocity through the network (or a portion of the network); an average value for velocity over time; a projected or goal value for velocity through the network; and other related values. Other information may be displayed in conjunction with the velocity information and/or the velocity value information. This other information may include factors that impact the velocity—traffic, weather, accidents, construction or maintenance, etc.—and the information may be associated with either or both of time/date and velocity value deviations. Thus, a user may select a day to see what the network velocity was on that day for a route or an asset, the historical average velocity for that same route or asset, the value associated with the difference between the historical average and the actual velocity for that day, and any velocity affecting factors (such as a snowstorm that occurred on that day).

In one embodiment, the application may suggest an asset deployment change to address diagnostic or prognostic conditions calculated based on uploaded data from an asset. The asset deployment change may be, for example, replacing out an asset with a prognostically poor outlook with another asset with a prognostically better outlook. Other application suggestions may be based on assigning asset health relative to mission criticality and/or assigning power availability based on power needs.

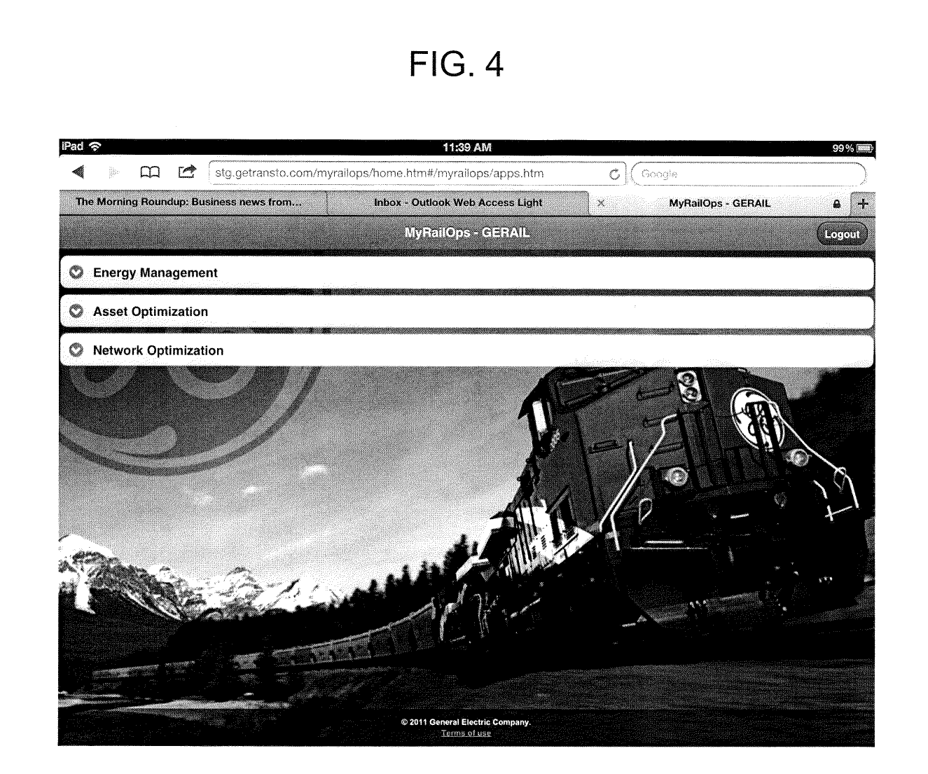

FIG. 4 shows an exemplary embodiment of a display screen of a home page of the data provisioning application 5 of the system 1 of FIG. 1. As shown by the home page, the data provisioning application includes three main sections or portions including energy management, asset optimization, and network optimization. In accordance with an embodiment, the sections or portions are implemented as software management modules. Energy management is concerned with the energy use of assets including fuel optimization for fuel savings. Asset optimization is concerned with remote monitoring, diagnostics, and repair with respect to assets, as well as asset management (e.g., rail car management). Network optimization is concerned with the movement planning or routing of assets through a transportation network.

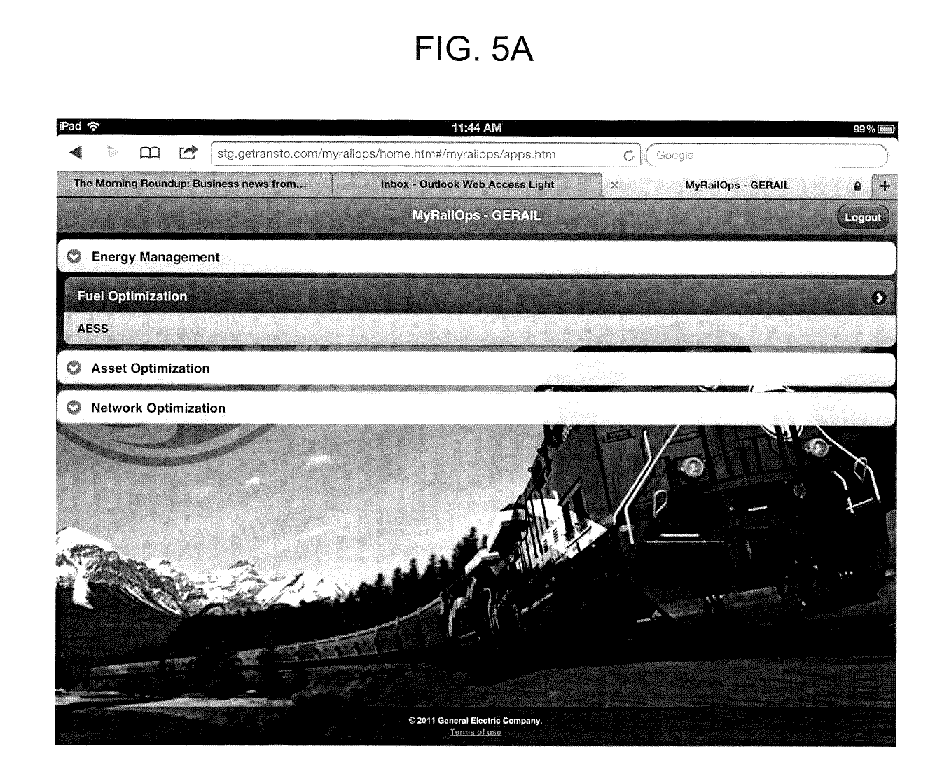

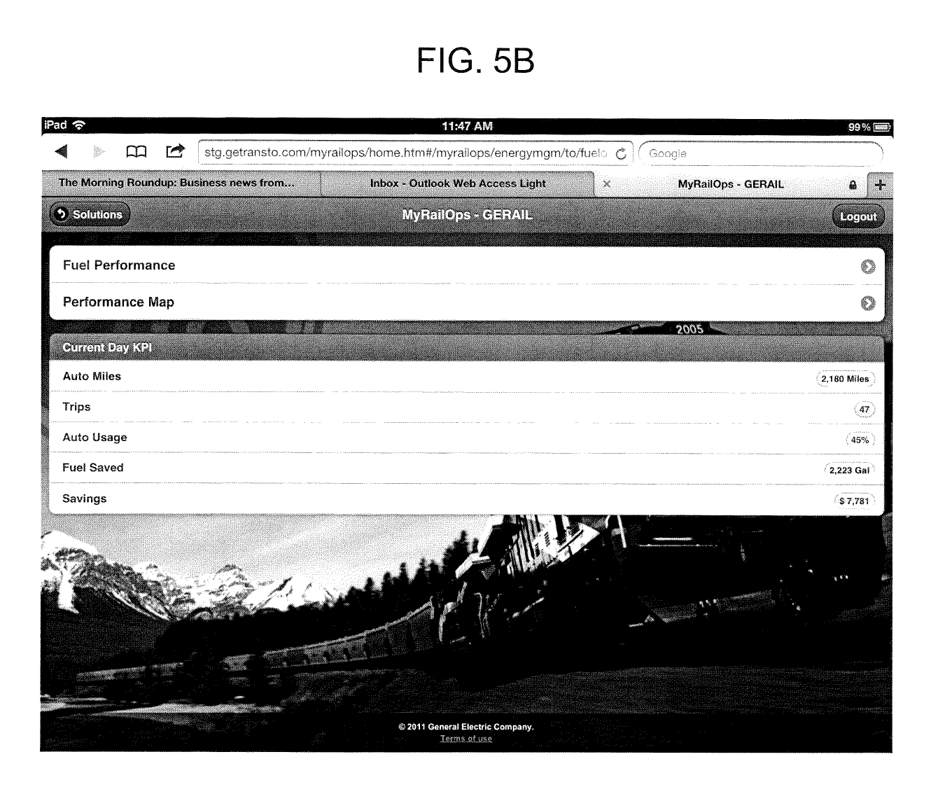

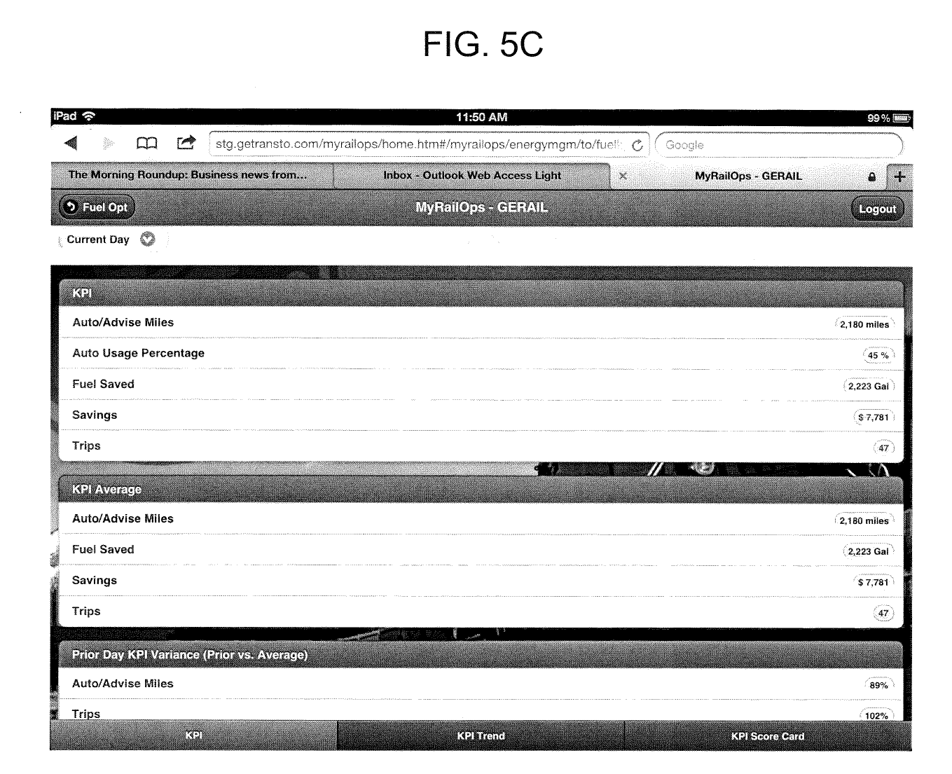

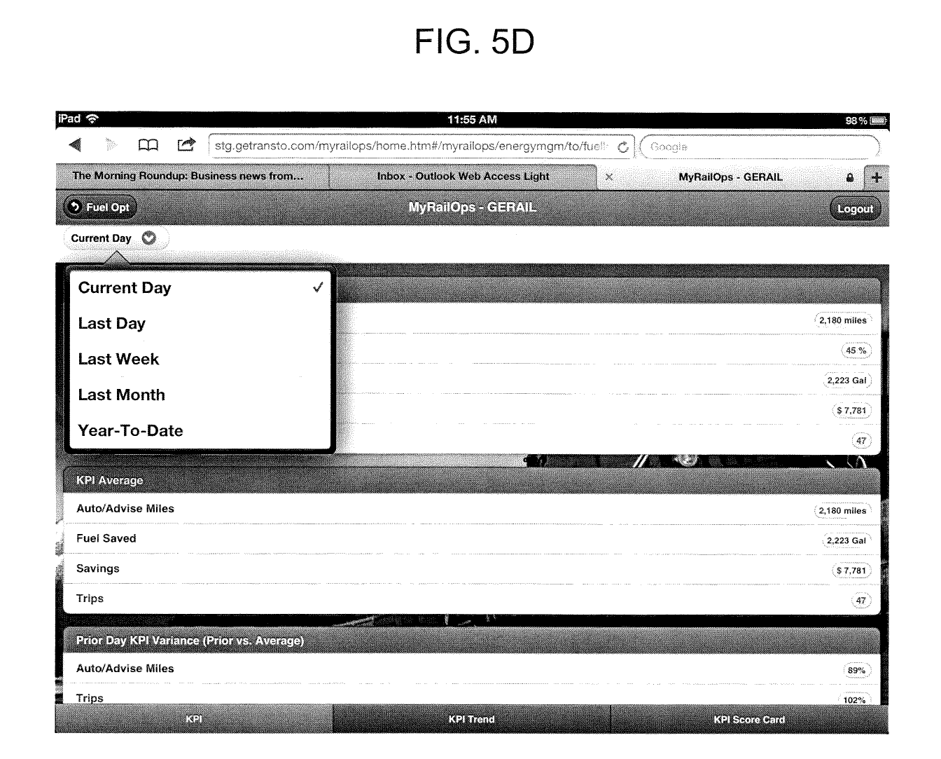

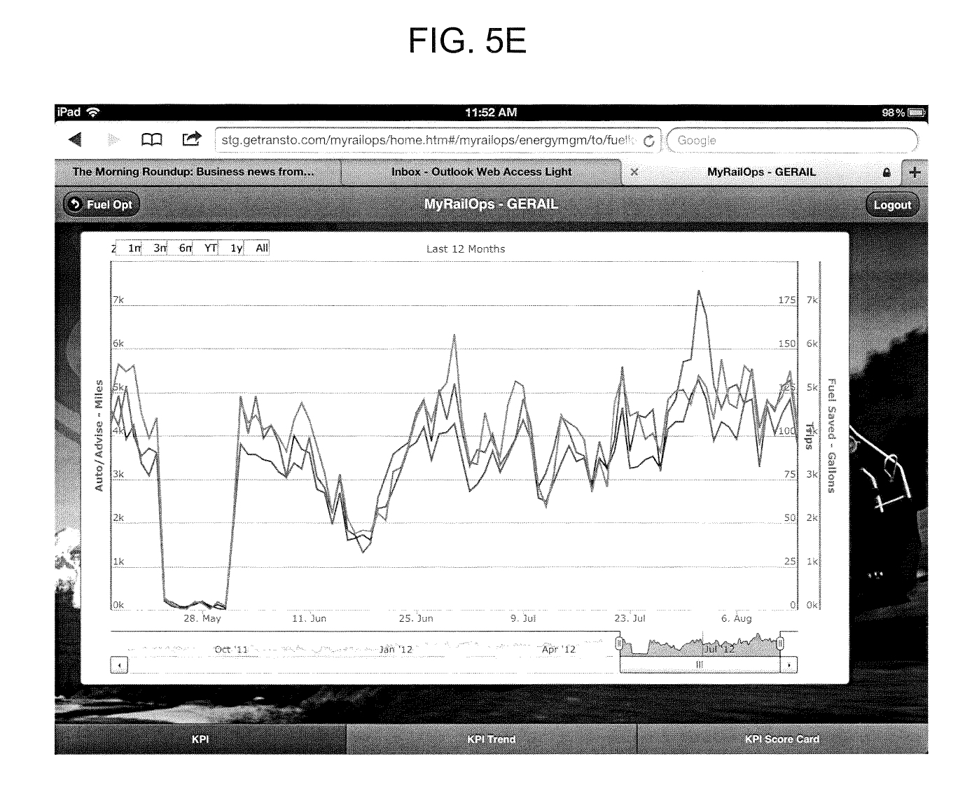

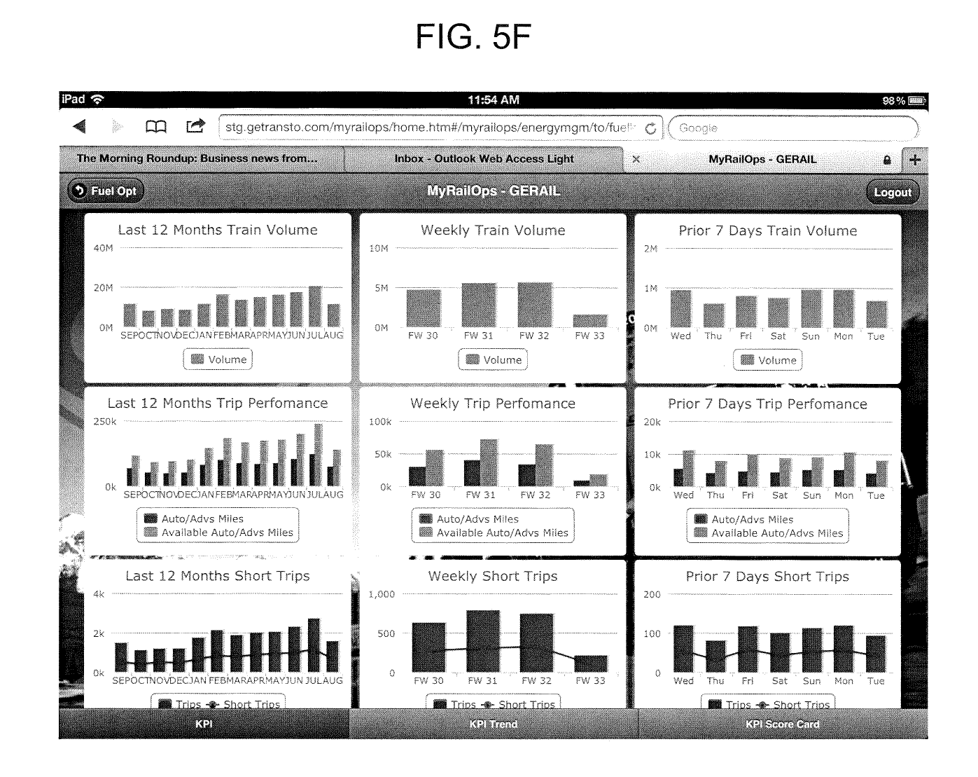

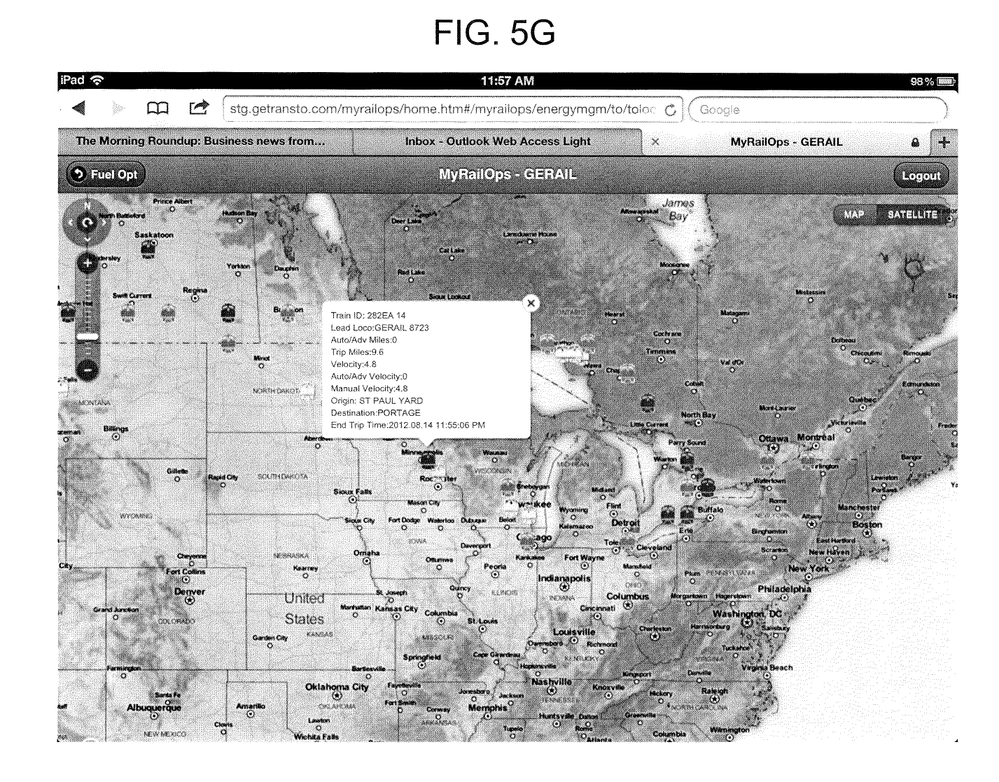

FIGS. 5A-5G show exemplary embodiments of display screens of an energy management portion of the data provisioning application 5 of the system 1 of FIG. 1. As seen in FIG. 5A, the energy management portion includes sub-sections of fuel optimization and auto engine start stop (AESS) related to energy savings systems. The various display screens show KPI information (FIGS. 5B-5D) with respect to fuel performance for a fleet of assets along with associated trend information (FIG. 5E), score card information (FIG. 5F), and map information (FIG. 5G).

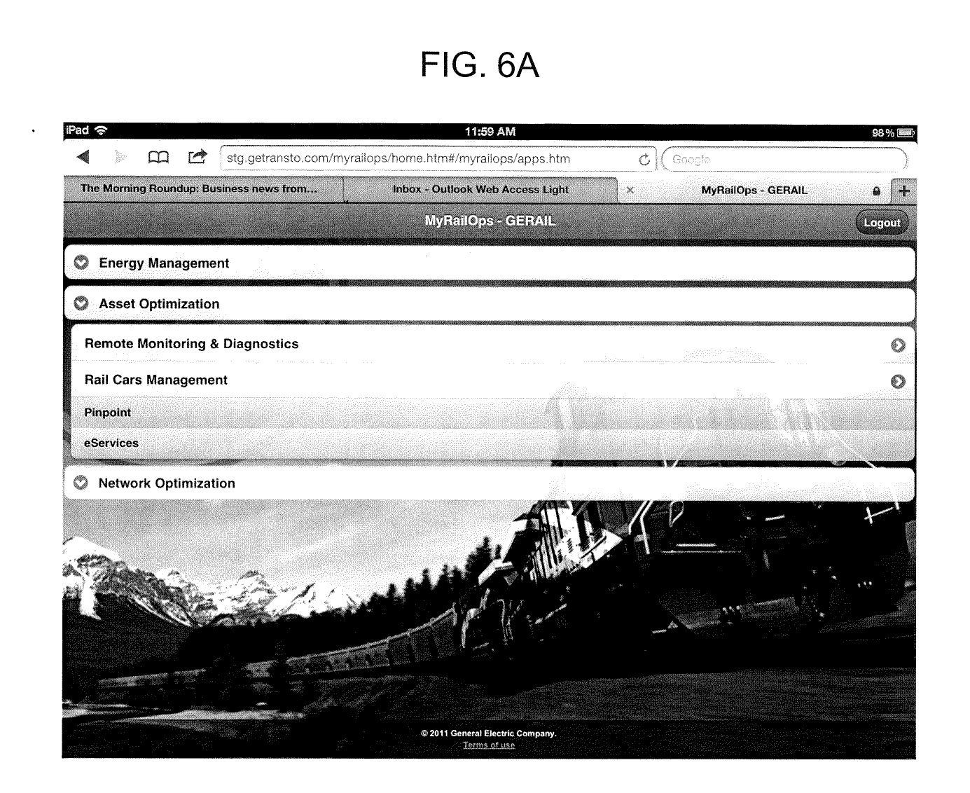

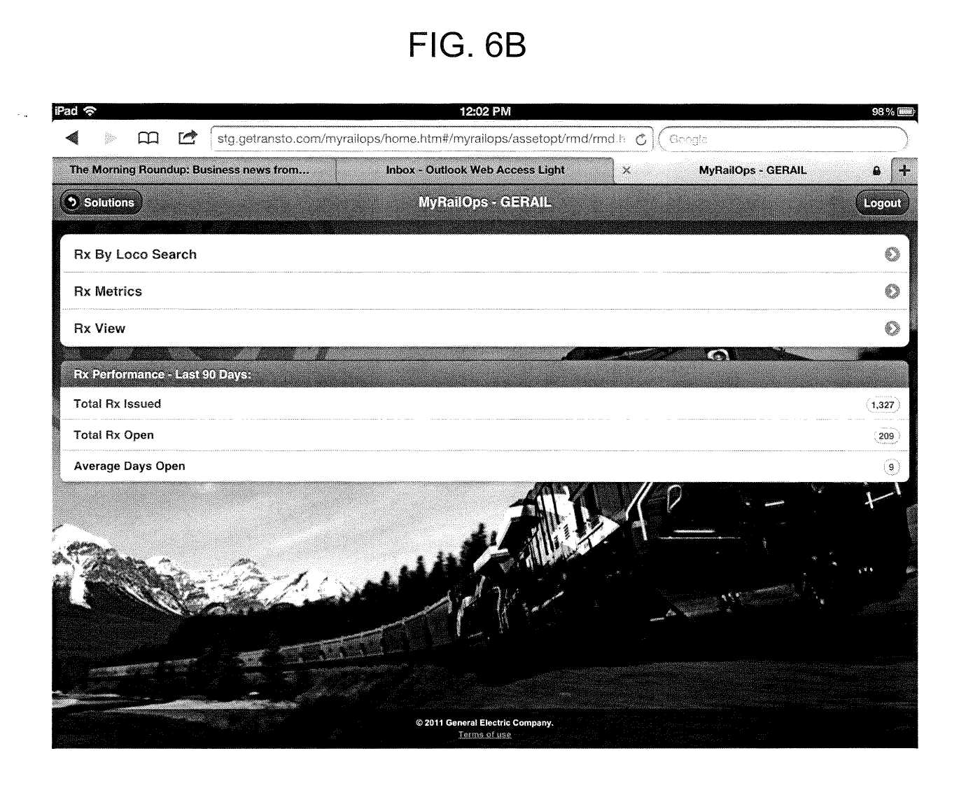

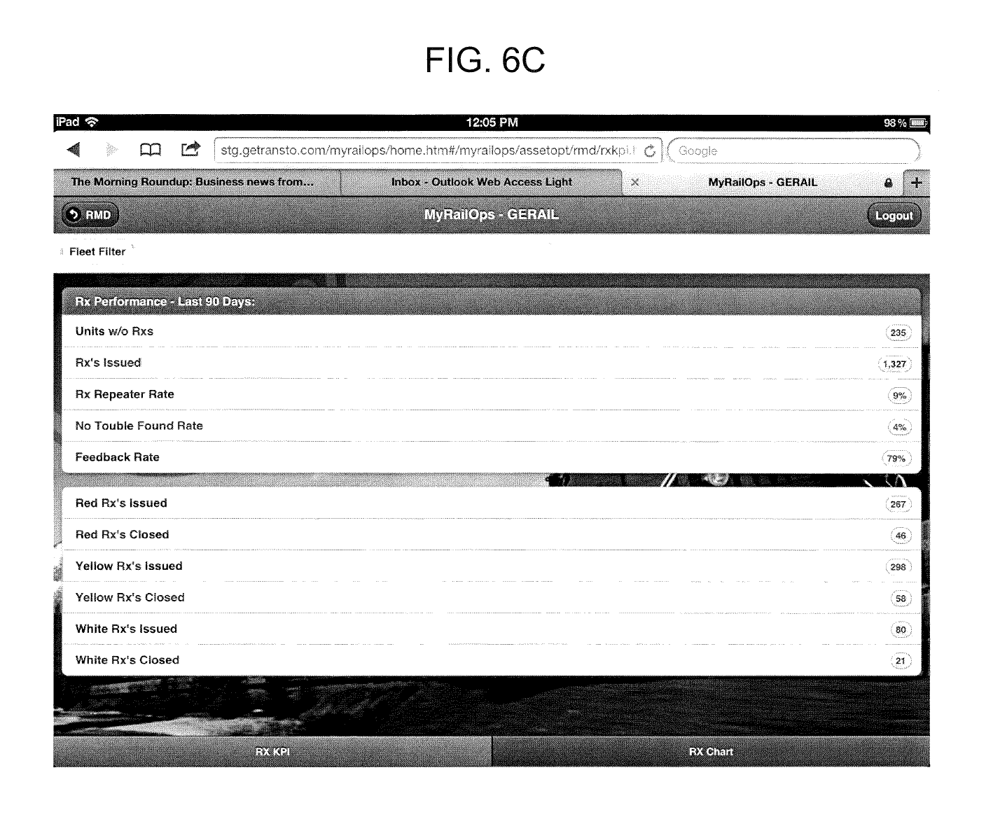

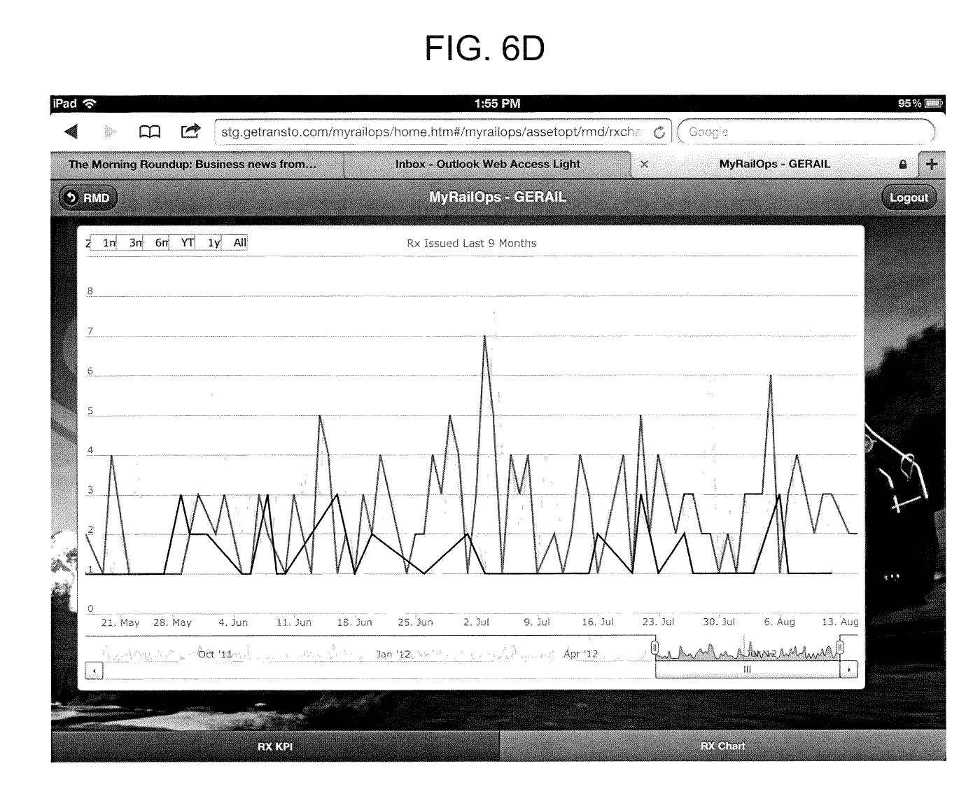

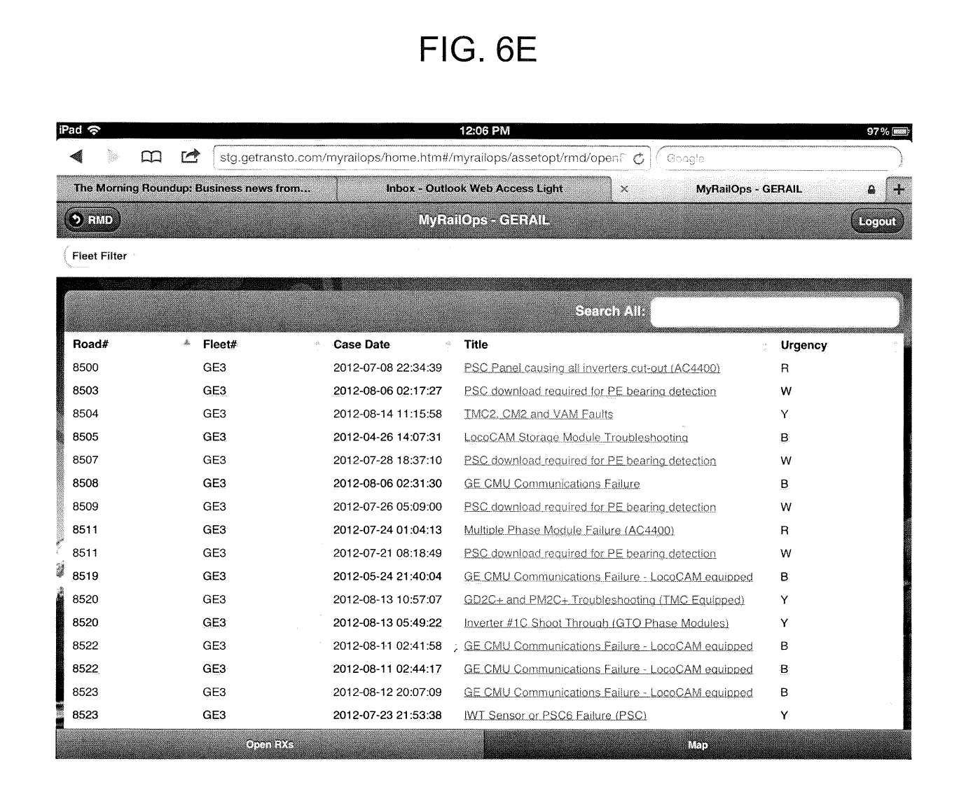

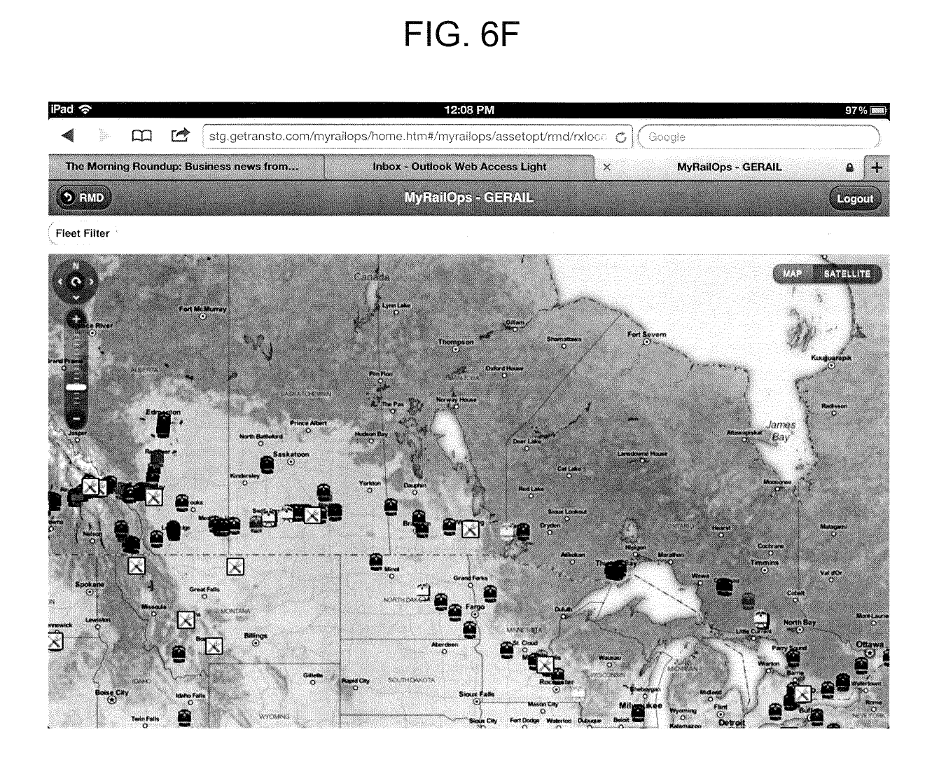

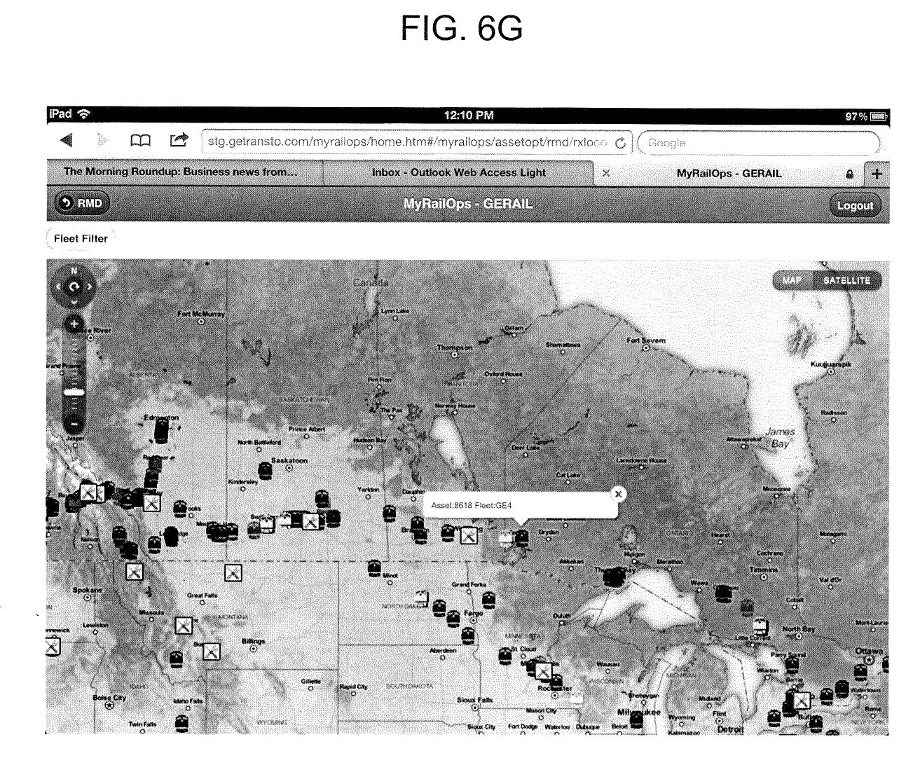

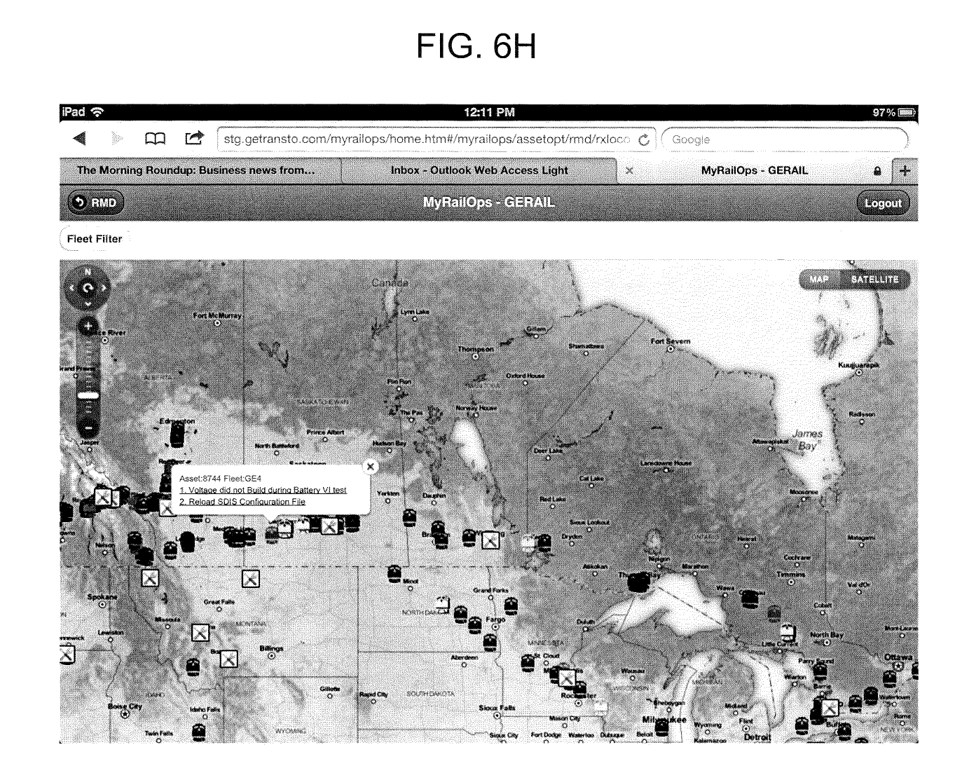

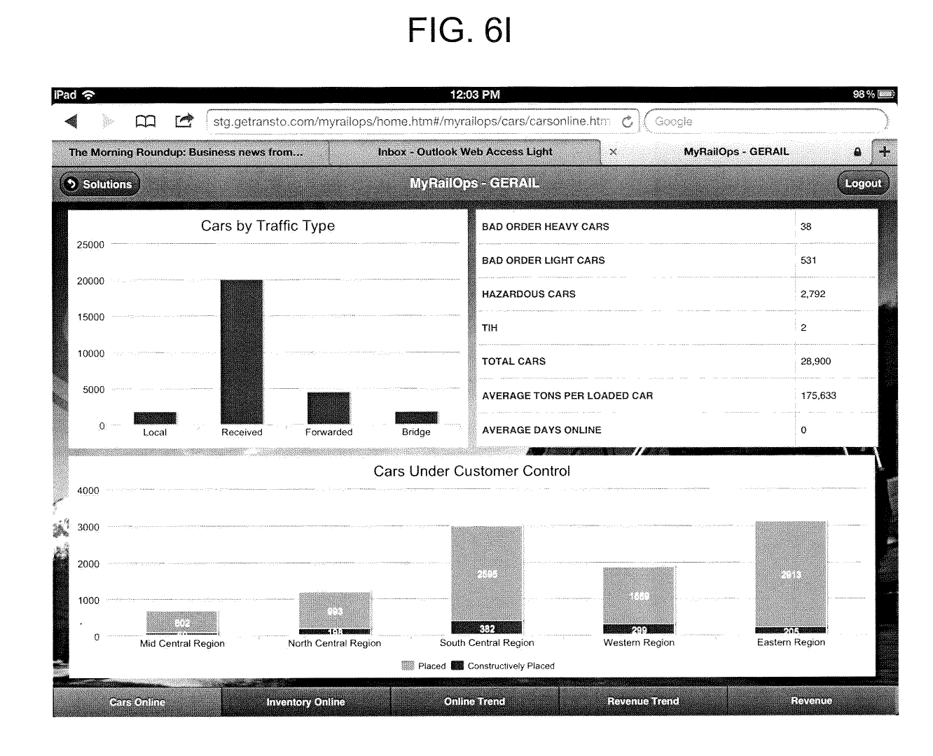

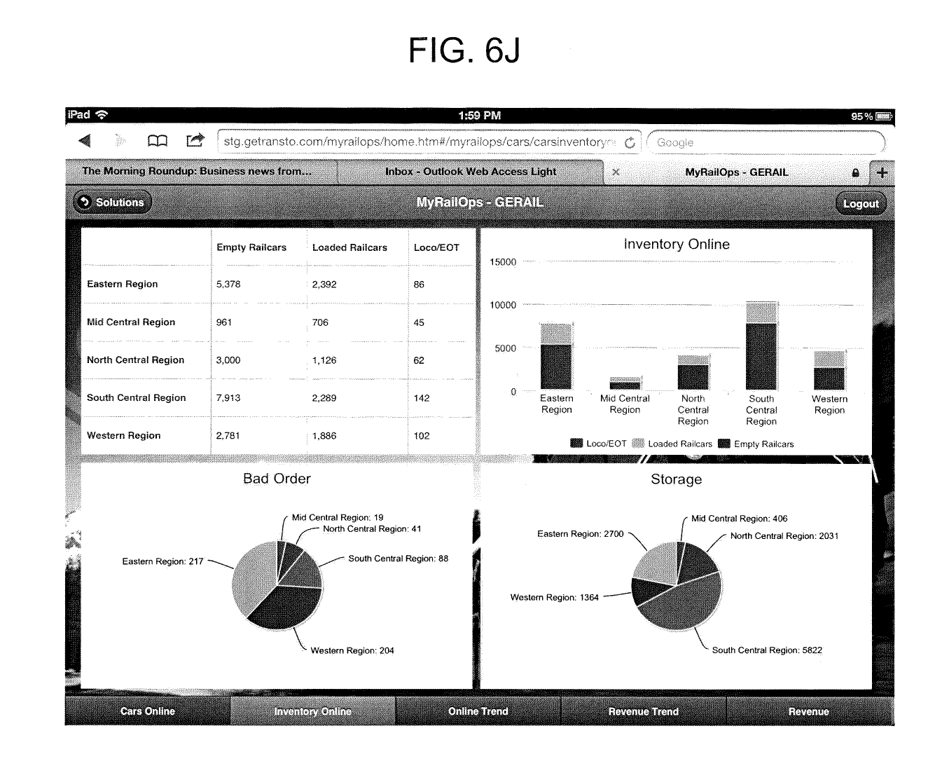

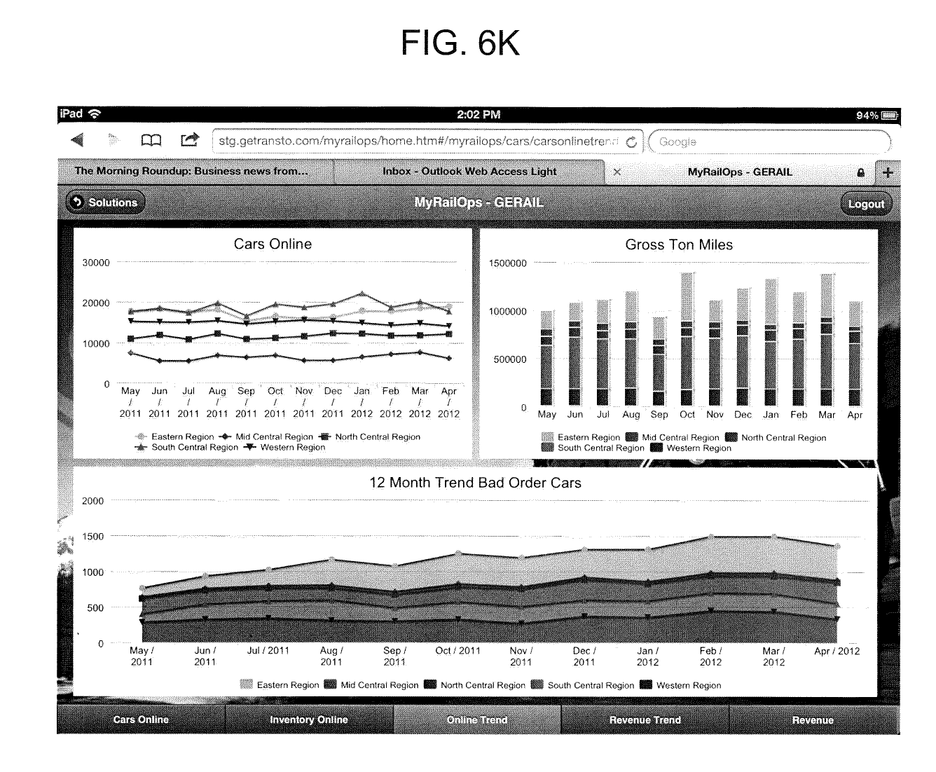

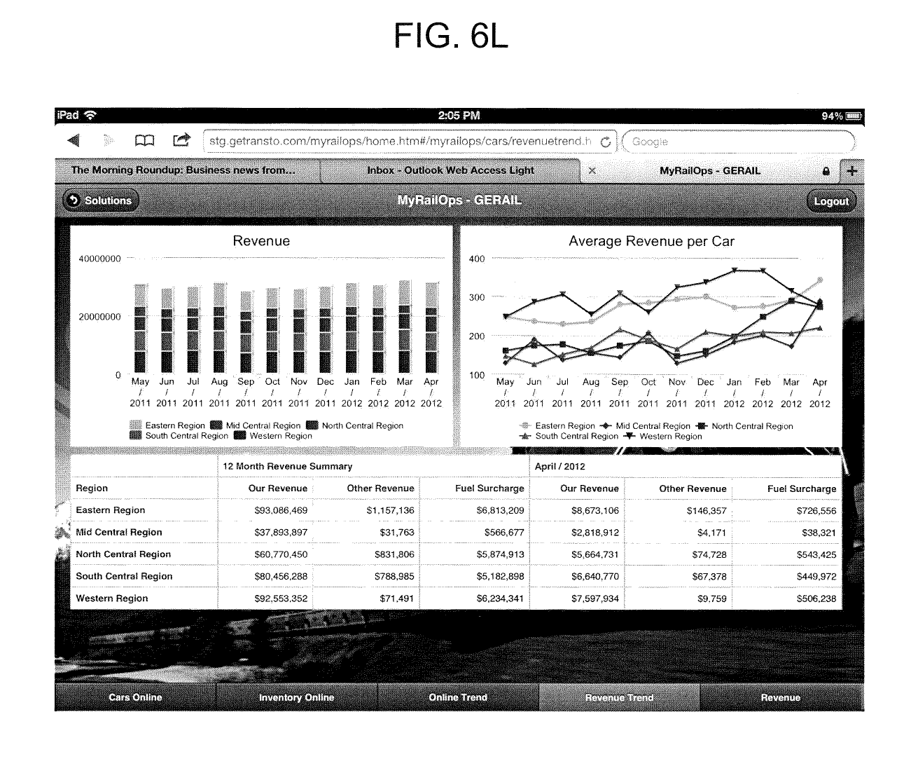

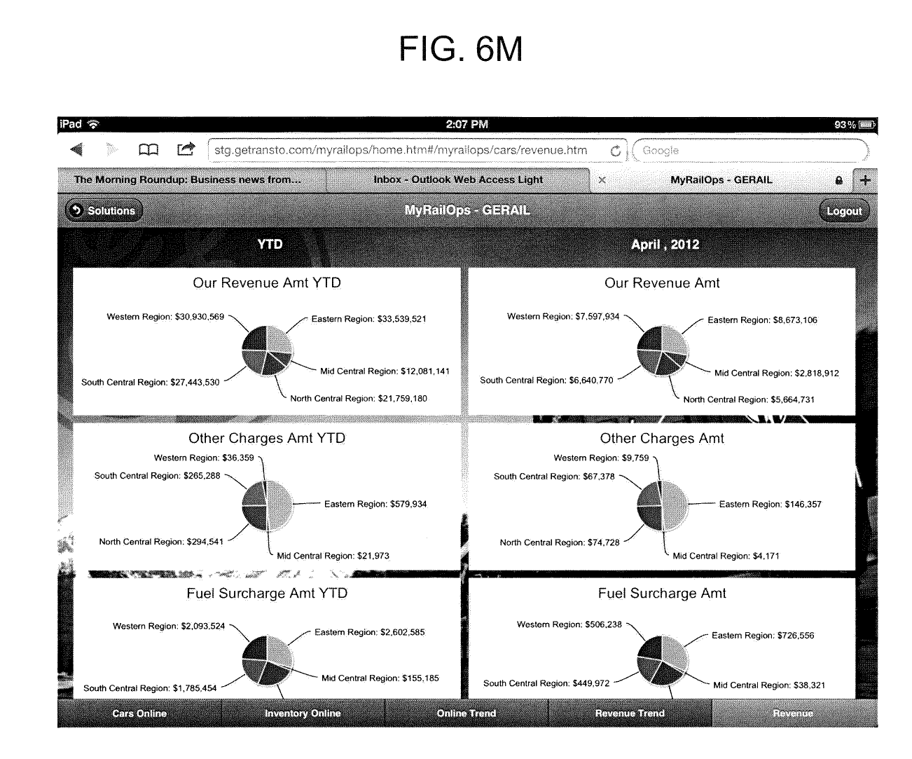

FIGS. 6A-6M show exemplary embodiments of display screens of an asset optimization portion of the data provisioning application 5 of the system 1 of FIG. 1. As seen in FIG. 6A, the asset optimization portion includes sub-sections of remote monitoring and diagnostics, rail cars management, pinpoint, and eServices. Certain display screens show Rx KPI information and metrics with respect to remote monitoring and diagnostics in various view, chart, and map forms (FIGS. 6B-6H). Other display screens show rail car management information including cars on-line (FIG. 6I), inventory on-line (FIG. 6J), on-line trend (FIG. 6K), revenue trend (FIG. 6L), and revenue (FIG. 6M).

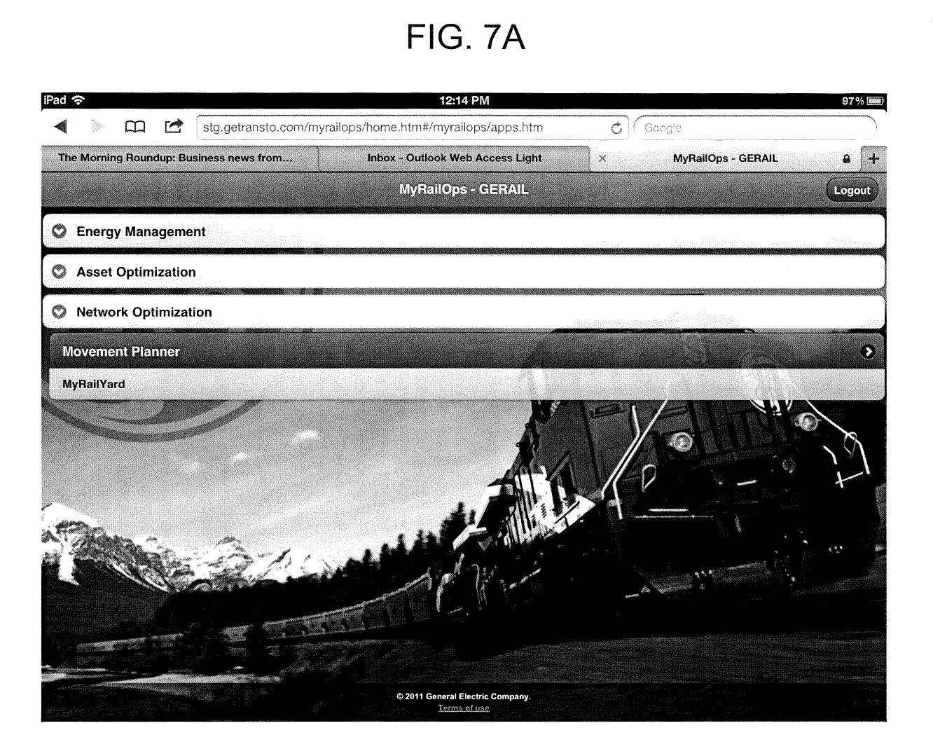

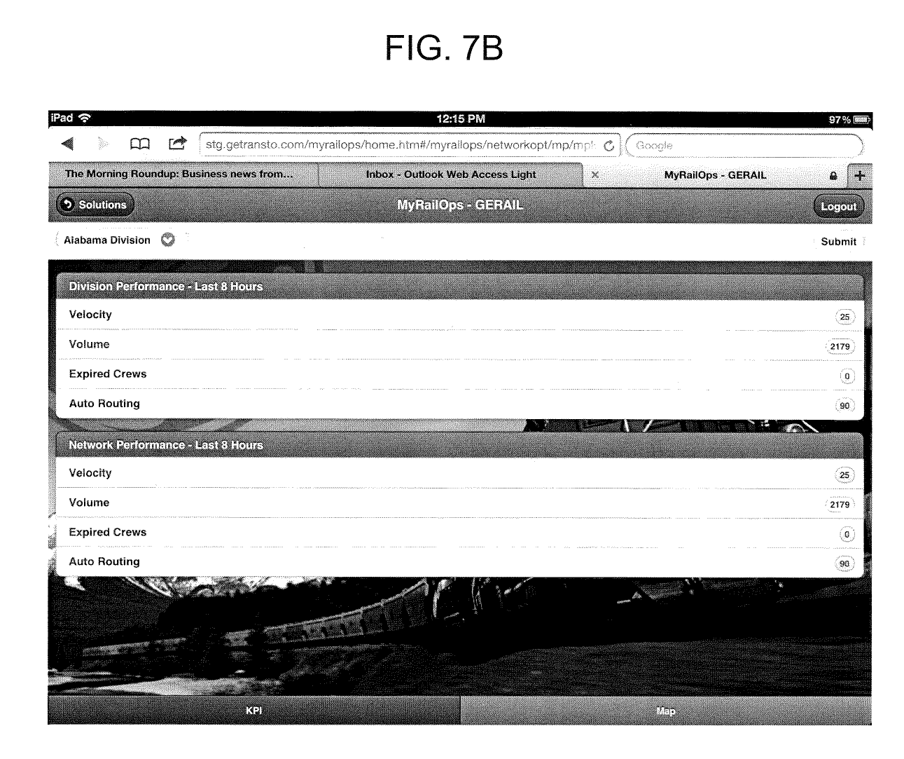

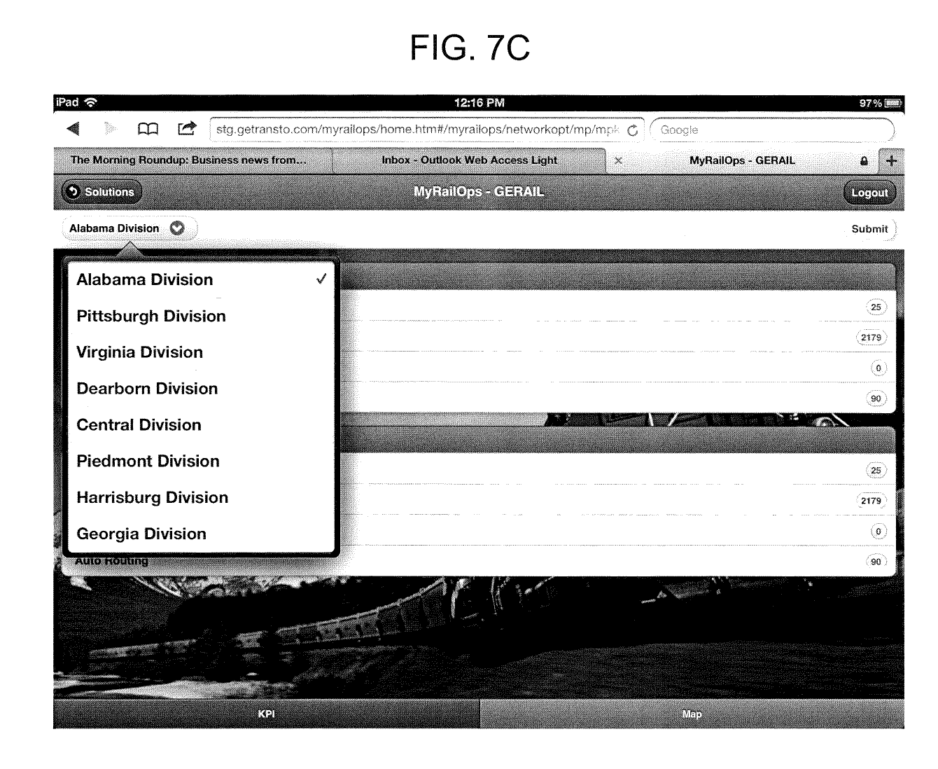

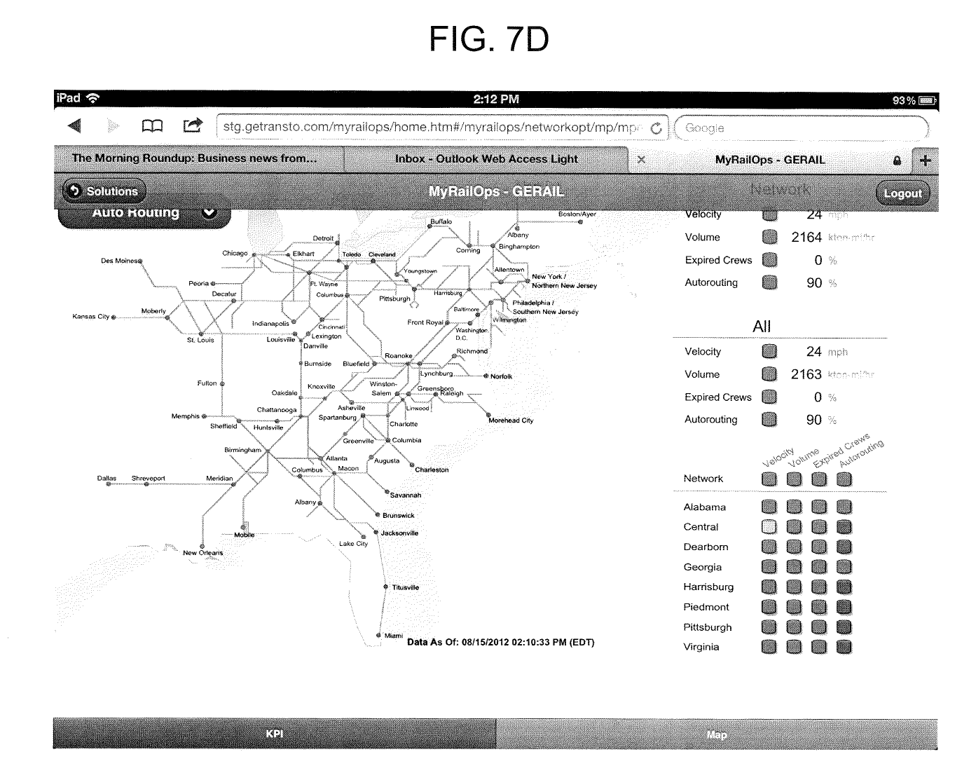

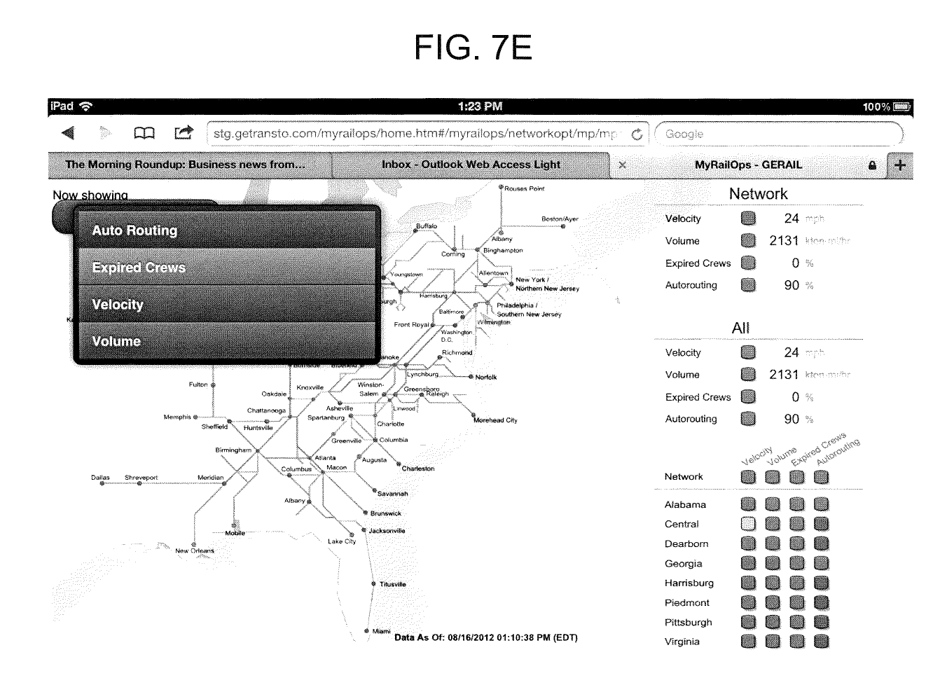

FIGS. 7A-7E show exemplary embodiments of display screens of a network optimization portion of the data provisioning application 5 of the system 1 of FIG. 1. As seen in FIG. 7A, the network optimization portion includes sub-sections of movement planner and MyRailYard. FIGS. 7B-7C are display screens showing movement planner KPI information (velocity, volume, expired crews, auto routing), selectable by division. FIGS. 7D-7E are display screens of a related movement planner map, providing views that are selectable by auto routing, expired crews, velocity, and volume.

With reference to the drawings, like reference numerals designate identical or corresponding parts throughout the several views. However, the inclusion of like elements in different views does not mean a given embodiment necessarily includes such elements or that all embodiments of the invention include such elements.

The above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those having ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

To the extent that any drawing figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

Furthermore, references to “one embodiment” of the present invention are not intended to be interpreted as excluding the existence of additional embodiments that also incorporate the recited features. The term display and cognates thereof include informational conveyances that are not visual, except where context or language dictates otherwise, and so include verbal and tactile signals.

In the specification and claims, reference will be made to a number of terms having the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system comprising:
a data center having at least one database containing metric value information about a fleet of assets;
a data communication infrastructure; and
a controller operable to implement a management module that is configured to display on a display of the controller at least one metric value for the fleet of assets, the at least one metric value obtained from the data center via the data communication infrastructure, and the at least one metric value includes at least one of an energy consumption metric value of the fleet of assets or a value for an energy saving system of the fleet of assets.

2. The system of claim 1, wherein the at least one metric value further includes a percent of time the energy saving system is in use verses the available amount of time the fleet of assets is in use and a set of determined conditions are met signifying that the energy saving system is available for use.

3. The system of claim 2, wherein the amount of time that the energy saving system is available for use is based on one or more of weather, equipment condition, environmental considerations, and available usage knowledge.

4. The system of claim 1, wherein the energy saving system is a trip plan fuel optimization system.

5. The system of claim 1, wherein the fleet of assets comprises at least one rail vehicle consist having one or more powered rail vehicles, and wherein the energy saving system is a consist management system for the rail vehicle consist.

6. The system of claim 1, wherein the metric value further includes an amount of fuel saved by the energy saving system over a period of time.

7. The system of claim 1, wherein the energy saving system is an engine control system configured to start and/or stop at least one engine of the fleet of assets.

8. The system of claim 1, wherein the metric value further includes a cumulative miles of travel of the fleet of assets, or a subset of the fleet of assets, within a selected period.

9. The system of claim 1, wherein the energy consumption metric value includes a cumulative amount of fuel used by the fleet of assets, or by a subset of the fleet of assets, over a period of time.

10. The system of claim 1, wherein the management module is further configured to display one or more status values associated with assets from the fleet of assets.

11. The system of claim 1, wherein the management module is further configured to display asset usage information associated with assets from the fleet of assets.

12. The system of claim 11, wherein the asset usage information comprises one or more of:
information on asset movement through a network, wherein the information on asset movement through the network comprises one or more of velocity, volume, expired crews, asset characteristics, or number of instances where a routing change was recommended by a network optimization system;
information on asset movement in an area for asset operations, wherein the area for asset operations is a rail yard and the assets are rail vehicles;
information regarding one or more of weather, traffic, environmental conditions, and route status; or
data about an operator or user of an asset.

13. The system of claim 11, wherein asset usage information is displayed graphically using at least a map of a determined network through which the assets move during operation.

14. The system of claim 13, wherein the management module is further configured to display on the map that includes one or more indicia of an accident, derailment, slow order, instance that caused a litigation event, a regulatory compliance regime differential based on geographic boundary, or an environmental condition.

15. The system of claim 13, wherein the management module is further configured to display weather information on the map, where the weather information being displayed on the map corresponds to the weather occurring at the geographic location corresponding to a map location at a select time.

16. The system of claim 13, wherein the management module is configured to respond to user input to tag an asset or a group of assets of the fleet of assets, and thereby to find, identify, or both find and identify the tagged asset or group of assets.

17. The system of claim 13, wherein the controller is further configured to:
initiate an upload of data from an asset of the fleet assets, or
receive an upload from the asset, wherein the asset is configured to initiate the upload of data in response to a defined event detected at the asset, and wherein the defined event comprises one or more of an accident, a critical fault, a mission failure, a lack of motion for a defined time, or an asset operator signal.

18. The system of claim 1, wherein the management module is further configured to provide information or feedback to a supply chain logistics application, wherein the provided information or feedback includes prognostics information.

19. The system of claim 1, wherein the management module is configured to perform one or more of:
providing an alert for operational deviations of an asset of the fleet of assets, or
automatically dispatching a repair or rescue crew if movement of the asset stops unexpectedly.

20. The system of claim 1, wherein the management module includes a cost calculator for velocity differences, and is further configured to display cost information based on a velocity difference between a measured velocity and a reference velocity, wherein the reference velocity comprises one or more of a historical average velocity, a target velocity, or a benchmark velocity.

21. The system of claim 1, wherein the management module is further configured to suggest a change to asset utilization or deployment based on one or more of an asset diagnostic condition, an asset prognostic condition, or a mission criticality factor.

22. A data provisioning method, comprising:
querying a database for one or more asset metric values associated with corresponding one or more key performance indicators (KPI) relating to assets that are part of a fleet of assets that exist in a network;
displaying the one or more metric values associated with the KPI on a map, and with one or more asset graphics associated with the assets disposed graphically on the map, wherein the respective dispositions of the asset graphics indicate location values of the assets, and wherein the asset graphics are configurable to convey information; and
an application responding to the metric values associated with the assets to configure the asset graphics to reflect the associated metric values.

23. The method of claim 22, wherein displaying comprises retrieving and displaying the one or more metric values reflecting KPI associated with energy consumption by one or more of the assets, usage of one or more of the assets, or status of one or more of the assets.
